(19) United States
(12) Patent Application Publication
(10) Pub. No.: US 2007/0266043 A1
(43) Pub. Date: Nov. 15, 2007

(54) Method, Server and Equipment Permitting the Development of a File Library

(76) Inventor: Nicholas Phelps, Paris (FR)

Correspondence Address: FULBRIGHT & JAWORSKI, LLP, 666 FIFTH AVE, NEW YORK, NY, 10103-3198, US

(21) Appl. No.: 11/658,942

(22) PCT Filed: Jul. 21, 2005
(86) PCT No.: PCT/FR05/50603

§ 371 Date: Jul. 16, 2007

(30) Foreign Application Priority Data
Jul. 29, 2004 (FR) 0451719

(51) Int. Cl. G06F 17/30

(52) U.S. Cl. 707/102; 707/E17.01

(57) ABSTRACT

The invention relates to a method permitting, in a simple and ergonomic manner, the development of a file library associated with a software product determined by a user, this user having an item of computing equipment. The inventive method comprises: a step, for the operator, of associating, with each file, a presentation file to which items of destination information including the specification of a determined location of the file library are associated so that the presentation files can be presented in the item of equipment of the user at the same time the presentation files are already located in the library.

### CROSS-REFERENCE TO RELATED APPLICATIONS

This application is a §371 from PCT/FR2005/050398 filed May 31, 2005, which claims priority from FR 04/51128 filed Jun. 8, 2004, each of which is herein incorporated by reference in its entirety.

### BACKGROUND OF THE INVENTION

The invention relates to a method permitting an operator to develop remotely, in a simple and ergonomic manner, a library of files of, for example, multimedia type, associated to a user's computer processing means. It also relates to a computer processing means using the method.

Computer processing means such as software and, in particular, software packages, create file libraries wherein the users may search for and select files (image, audio, video, text etc) that they require. For example, a graphic artist uses image files to create an original composition or a musician uses different audio files to create a piece of music.

These file libraries are most often associated directly to a software program, making it possible for users to access their contents without exiting the software. Files are thus searched for and inserted using a function of the software in question, notably an import function. With this function, the user can access a tree structure showing the files, which are filed under various different possible categories, notably by theme, date and by file size.

The advantage of such file libraries which are associated to the same software program lies in their ability to develop through the addition of new files in order to respond to the needs expressed by the users. It is preferable that the development of file libraries satisfy certain conditions for the users and for the publishers. On one hand, the users of the software in question must be able to develop their file libraries quickly (by accessing the files which interest them directly), in a simple manner (by carrying out a minimum number of operations) and in an organised fashion (by filing the new files in the appropriate sections of the existing tree structure). On the other hand, the file distributors, notably software publishers, must be able to propose these new files in an efficient and targeted manner to the users of the software in question.

Various methods are known in prior art for distributing files, notably of multimedia type, using different types of media such as floppy disk, CD-ROM or DVD-ROM, or Websites selling content remotely. These different methods of distribution present the disadvantage of necessitating interventions on the part of the user to produce a presentation and categorisation of files.

### SUMMARY OF THE INVENTION

The present invention satisfies the conditions stated above by adapting in real time the offer of new files to the requirements of software users.

The invention relates to a method permitting a user having computing equipment with a file library associated to a specified software program, to develop, in a simple and ergonomic manner, this file library. The term “file library” refers to files which are installed in a permanent manner on the user's equipment.

The method in accordance with an embodiment of the present invention comprises for an operator, the preliminary step of generating, for each file to be transmitted to users, a thumbnail representing, notably in a visual and/or audio manner, the file, the size of the thumbnail, i.e., its number of bits, being preferably substantially smaller than the size of the file that it represents. Each thumbnail being associated to: destination information, notably the specification of a given location in the file library and/or a presentation location in the group of presented thumbnails.

Preferably, information relating to the terms and conditions of acquisition and use of the file is associated to each thumbnail. In the case where the operator distributes a thumbnail or presentation file via a distribution server connected to a communications network, a link can be provided in this case, notably of hypertext type, permitting the user to proceed with payment for the acquisition of the file.

In an embodiment, the link permits access to a remote payment platform connected to a remote server via the computer communications network.

In an embodiment, the link permits access to an account, on the operator's server for example, wherein a credit is written in favor of the user, this credit being reduced by the price of the file once this is acquired by the user.

Various other objects, advantages, and features of the present invention will become readily apparent from the ensuing detailed description, and the novel features will be particularly pointed out in the appended claims.

### DETAILED DESCRIPTION OF THE EMBODIMENTS

The files can be acquired using a media device such as a floppy disk, a CD-ROM or DVD-ROM, a memory card, a USB key etc. In this case, the downloading and/or use of files by the computing equipment is not generally possible until authorisation has been obtained, notably following payment.

The thumbnails can be placed in a presentation location for the user in such a way as to form a group with the thumbnails for files that have already been acquired. Under these conditions, the user sees immediately the group of thumbnails representing any previously acquired files that it can use, together with those that it will be able to use after acquisition. Preferably, a signal, or sign indicating that the corresponding file may be acquired is associated to each thumbnail that corresponds to a file that has not yet been acquired.

In general, the thumbnails for acquired files and the thumbnails for non-acquired files are identical or analogous so that the user may benefit from the above-mentioned group presentation.

The thumbnail, or presentation file, thus obtained is intended to present the user with a preview of the corresponding file, notably in the form of a summary and/or a sample. In the case of a visual thumbnail, the representation comes in graphic (image) or text format.

In an embodiment, the files are 3D images (three-dimensional images) and the thumbnails are 2D images (two-dimensional images), reduced in size but nonetheless providing a sufficient preview of the 3D image to allow the user to establish whether or not the file meets its requirements. It should be noted here that, in this application, the two-dimensional presentation can give a full preview of the three-dimensional representation, while minimizing the load in terms of memory on the user's computer equipment and, in the case of downloading from a server, on the communications network during the downloading of the presentation file. In general, a 2D representation is a file of several kilobytes, whereas a 3D representation file can take up several, even tens of megabytes. In other words, in this application, the presentation file represents the full file while minimizing the load in terms of memory on the communications network, during downloading, as well as on the user's computer equipment.

The present method also includes the step of downloading the presentation file to the computing equipment. This downloading procedure is carried out either using a distribution server, via the computer communications network, or by using a media reading device such as a floppy disk drive, a memory card drive, a USB key drive, a CD or DVD-ROM drive etc. This download operation has the advantage of speed since the presentation file is, as described above, a file of reduced size and/or, preferably, a 2D image of a 3D representation and/or a sample of the original file.

In one variation, which is more ergonomic for the user, but which does not present the advantages of speed during the download operation, the full file is downloaded at the same time as the corresponding presentation file (thumbnail); in this case, if the use of the downloaded file is subject to purchase, provisions can be made for a means to inhibit the use of this file but not the access to its thumbnail, until a payment of a price or equivalent has been made. In one variation, a temporary access can be provided to the full file (trial period).

The presentation thumbnails are stored in a specified location in the file library, according to destination information. Thus, instead of being imported to a random location on the computer equipment hard disk, the presentation file is, without need for user intervention, filed in a pertinent location in the file library in compliance with its tree structure. No tedious intervention is therefore required on the part of the user for organising downloaded items. Moreover, even in the assumption where the user has personalised this tree structure by modifying the original segmentation programmed by the software publisher, the destination information will ensure that the filing system remains pertinent when storing presentation files in the file library.

The viewing of thumbnail files by the user is thus more ergonomic because, as is described above, the newly downloaded presentation files are stored, within the file library, in the same memory segments as the presentation files already stored in the computer equipment's memory.

Alternatively, for new file types for example, the newly downloaded thumbnails are stored in a newly available segment. Viewing files in this way allows the user to acknowledge technical and/or aesthetic characteristics of the new file that is being offered together with its price and terms and conditions of use.

If, after viewing the presentation file, the user wishes to acquire the full file that it represents, this user may activate the link to access for example the platform or the remote payment server. This remote payment platform will allow the user to pay the price corresponding to the full file instantly.

Alternatively, as specified above, provision can be made, for example on the file distribution server, for an account for each user corresponding to a pre-payment and this account is debited upon each file acquisition according to the price of the file.

The method also includes the step of downloading the full file corresponding to the presentation file to the user's computing equipment, for example via a computer communications network. As soon as the payment has been validated by the remote payment platform, the distribution server will transmit, via the computer communications network, the full file to the user's computing equipment.

The method also includes the step of storing the file in the file library to complement the presentation file.

Alternatively, the full file replaces the presentation file, the location of the full file in the file library being, for example, identical to that of the presentation file. The simplicity and ergonomics of use of the full file are well ensured.

According to an embodiment of the present invention, in the case where files are distributed by a telecommunications network, the downloading of the presentation file to the computing equipment is activated automatically by the specified software and/or by the distribution server according to a regular frequency. This means that the user does not need to take steps to enquire as to the existence of any new files that it may require. The downloading of presentation files takes place automatically and in a regular manner and is initiated either by the user's software (which activates a computer connection with the operator's distribution server on a regular basis) or by the operator's distribution server (which activates a computer connection with the user's computing equipment on a regular basis).

According to another embodiment of the present invention, the settings for downloading the presentation file to the computing equipment are defined by the user, enabling them to select download criteria, notably the automatic or manual nature of downloads, the frequency of downloads and the themes of downloaded presentation files.

According to an embodiment of the present invention, the information included in the presentation file is such that it allows the user to access at least one additional presentation, provided by the server, so that this user can have additional information on the full files. For example, for a 3D file the user can be provided with one or more additional views showing different viewing angles from that of the first thumbnail.

In one variation, a trial version is provided, possibly the full version, of the full file, this version being for example a restricted version and/or a version that is subject to a limited period of use.

In an embodiment of the present invention, the user's equipment has a command which will prevent the presentation and/or the downloading of thumbnails corresponding to files that have not yet been acquired.

In summary, the ergonomics that the user benefits from lie chiefly in the automatic storage of presentation thumbnails in locations that enable the presentation thumbnails corresponding to full files that have not been acquired to be presented at the same time as the thumbnails corresponding to the acquired files. The automatable and programmable nature of the presentation files download process also enhance the ergonomics for the user. These automatic and programmable downloads constitute another aspect of the invention which can be used independently from the first aspect, constituted by the downloading of presentation thumbnails referring to files that have not been acquired to the same segment as the thumbnails representing the acquired files.

The present invention also allows the operator, notably the file publisher, to propose files to the most likely users only and at the point in time when these users are potentially most likely to require them.

The present invention therefore makes it possible to adapt the offer of new files to suit the requirements of software users.

The files can usually be acquired individually. However, in one variation, provision can be made, on the operator's server, or within the thumbnails, or on the user's computer, for a system that prevents at least some files from being sold individually thereby offering them only together with their other associated files. The association between files corresponds, for example, to a theme such as a product type. For example, 3D files for automobiles may only be acquired as part of the group of automobiles for a given brand name.

In an embodiment of the present invention, to prevent the server from re-sending thumbnails that have already been downloaded at each download, this server stores thumbnails that have been sent in its memory.

Alternatively, the user's equipment transmits an identifier to the server specifying items that have already been downloaded or have not been downloaded, the identifier being a name or a number for the latest item downloaded, for example. In this case, the items downloaded are filed, for example by number and/or date and/or name. This order relation can be known by the only server.

In another embodiment of the present invention, the user's equipment sends the server the list of identifiers for all full files that have already been downloaded.

The present invention also relates to a user's computing equipment and a server for the application of the above-defined method.

In summary, the present invention relates to a method permitting, in a simple and ergonomic manner, the development of a file library associated to a specified user software product, the user disposing of computing equipment. This method comprises:

the step, for the operator, of associating to each file, a presentation file to which destination information is associated, including the specification of a given location in the file library, so that the presentation files can be presented in the user's equipment at the same time as the presentation files already located in the library.

According to an embodiment of the present invention, information relating to the terms and conditions of acquisition and use of the file is associated to each presentation file.

In an embodiment of the present invention, presentation information notifying that this file is not yet functional in the user's file library is associated to the presentation files for files corresponding to files that have not yet been acquired.

The downloading process can be carried out using a server connected to a communications network, notably of Internet type, to which the user's equipment is connected.

In this case, according to an embodiment of the present invention, the downloading of the presentation file to the computing equipment is activated automatically by the user's software and/or by the distribution server, preferably at a regular frequency. The parameters for this process, by which the presentation file is downloaded to the computing equipment, can be defined by the user by means of a parameterisation module enabling the selection of download criteria, notably the frequency of downloads and the themes of downloaded presentation files.

The size of the presentation file is preferably substantially smaller than the size of the file that it represents.

In an embodiment of the present invention, the user's equipment can be set up in such a way as to allow the obtaining of additional information relating to the presented file which has not yet been acquired in the user's file library.

In the case where the downloading operation is carried out via a telecommunications network, in order to avoid the server re-sending previously downloaded thumbnails upon each download operation:

the server stores the thumbnails that have been sent in its memory,

and/or

the user's equipment transmits an identifier to the server specifying items that have already been downloaded or have not been downloaded,

and/or

the user's equipment sends the server the list of identifiers for all full files that have already been downloaded.

The library files are, for example, of 3D type and the presentation files are of 2D type.

In an embodiment of the present invention, the presentation file is downloaded without the file that it represents.

Alternatively, the presentation file is downloaded at the same time as the file that it represents, or a trial version of this file, the file or its trial version being functional only under the specified conditions.

The present invention also relates to a user's computing equipment permitting, in a simple and ergonomic manner, the development of a file library associated to a given software product; this computing equipment comprising:

means for downloading presentation files intended for presenting full files to the user, and

means for presenting these presentation files at the same time as the presentation files for full files already acquired in the file library.

According to an embodiment of the present invention, the equipment comprises means for associating presentation information to the presentation file indicating that the corresponding full file has not yet been acquired in the user's file library.

The equipment can be connected to a communications network, notably of Internet type, so that the downloading is carried out by means of a server connected to the network, and can include means so that the downloading of the presentation file to the equipment is activated in an automatic manner by the user's software, preferably at a regular frequency. In this case, according to one embodiment, the equipment comprises means so that the settings for downloading the presentation file to the computing equipment may be programmed by the user by means of a parameterisation module allowing the user to select download criteria, notably the frequency of downloads and the themes of downloaded presentation files.

In an embodiment of the present invention, the equipment comprises means for requesting additional information on a presented file which has not yet been acquired in the file library.

The equipment is preferably such that the library files are of 3D type and the presentation files are of 2D type.

In an embodiment of the present invention, the equipment comprises means so that the presentation file is downloaded without the file that it represents.

Alternatively, the equipment comprises means so that the presentation file is downloaded at the same time as the file that it represents, or a trial version of this file, the file, or its trial version being functional only under the specified conditions.

The present invention also relates to a distribution server enabling the operator to develop remotely, in a simple and ergonomic manner, a file library associated to a specified user software product, the user disposing of computing equipment connected, via a communications network, notably of Internet type, to the distribution server; the distribution server comprising:

means for sending destination information, including the specification of a given location in the file library, so that the presentation files can be presented in the user's equipment at the same time as the presentation files referring to full files that have already been acquired in the library.

According to an embodiment of the present invention, the server comprises means for sending information referring to the terms and conditions of use and acquisition of the file.

According to an embodiment of the present invention, the server comprises means for associating presentation information to the presentation file indicating that this file has not yet been acquired by the user's file library.

The server can comprise means so that the downloading of presentation files to the computing equipment is activated automatically, preferably at a regular frequency.

The server comprises, for example, means for ensuring that the size of the presentation file is substantially smaller than the size of the file that it represents.

For example, the library files are of 3D type and the presentation files are of 2D type.

In an embodiment of the present invention, the server comprises means so that the presentation files are downloaded to the computing equipment without the files that they represent.

Alternatively, the server comprises means so that the presentation file is downloaded at the same time as the file that it represents, or a trial version of this file, information being associated to the file or to its trial version so that the file or the trial version will only be functional under the conditions predetermined by the user's equipment.

While the present invention has been particularly described with respect to the illustrated embodiments, it will be appreciated that various alterations, modifications and adaptations may be made based on the present disclosure, and are intended to be within the scope of the present invention. It is appreciated that although the invention has been described with respect to derivative securities with any number of components, the disclosed invention may be similarly applied to derivative securities with one or more components. It is intended that the appended claims be interpreted as including the embodiments discussed above, the various alternatives that have been described, and all equivalents thereto.

1. A method for permitting, in a simple and ergonomic manner, the development of a file library associated to a specified user software product, comprising the steps of:
associating a presentation file to each file, said presentation file being associated with destination information including a specification of a given location in the file library; and
presenting said presentation files in a computer processing equipment of a user at the same time as said presentation files are stored in the file library.

2. The method of claim 1, wherein the step of associating comprises the step of associating information relating to the terms and conditions of use and acquisition of the file to each presentation file.

3. The method of claim 1, further comprising the step of associating presentation information notifying that a file is not yet functional in the file library of said user to said presentation file corresponding to said file that has not yet been acquired by said user.

4. The method of claim 1, wherein said computer processing equipment of said user is connected to a communications network; and further comprising the step of downloading said presentation file from a distribution server connected to the communications network.

5. The method of claim 4, further comprising the step of automatically activating the step of downloading said software product and/or said distribution server at a predetermined interval of time.

6. The method of claim 5, further comprising the step of programming settings for downloading of said presentation file to said computer processing equipment of said user by said user by means of a parameterization module which allows said user to select download criteria.

7. The method of claim 1, wherein the step of presenting comprises the step of presenting said presentation file which is substantially smaller in size than the size of corresponding file.

8. The method of claim 1, further comprising the step of obtaining additional information relating to said presentation file presented to said computer processing equipment but not acquired by the file library of said user.

9. The method of claim 4, further comprising at least one of the following steps to avoid the destination server re-sending previously downloaded thumbnails upon each download operation:
storing thumbnails that have been sent to said computer processing equipment of said user by the destination server;
transmitting an identifier specifying items that have already been downloaded or have not been downloaded to the destination server by said computer processing equipment of said user; and
transmitting a list of identifiers for all full files that have already been downloaded to the destination server by said computer processing equipment of said user.

10. The method of claim 1, wherein library files are of three-dimensional type and said presentation files are of two-dimensional type; and further comprising the step of presenting two-dimensional presentation files in said computer processing equipment.

11. The method of claim 1, further comprising the step of downloading said presentation file without a corresponding full file.

12. The method of claim 1, further comprising the step of downloading said presentation file at the same time as the corresponding full file or a trail version of the corresponding full file, wherein said full file or said trial version being functional only under predetermined conditions.

13. A computing equipment for developing a file library associated with a given software product in a simple and ergonomic manner, said computing equipment comprising:
means for downloading presentation files corresponding to full files to be presented to a user; and
means for presenting said presentation files downloaded at the same time as presentation files corresponding to full files acquired in the file library of said user.

14. The computing equipment of claim 13, further comprising means for associating presentation information to a presentation file indicating that a full file corresponding to said presentation file has not been acquired in the file library of said user.

15. The computing equipment of claim 13, wherein said means for downloading comprises a server connected to a communications network; and further comprising means for automatically activating downloading of said presentation file to said computing equipment by said software product at a predetermined interval of time.

16. The computing equipment of claim 15, further comprising means for program settings for downloading of said presentation file to said computer processing equipment by said user by means of a parameterization module which allows said user to select download criteria.

17. The computing equipment of claim 13, further comprising means for requesting additional information on a presented file which has not been acquired in the file library of said user.

18. The computing equipment of claim 13, wherein library files are of three-dimensional type and said presentation files are of two-dimensional type.

19. The computing equipment of claim 13, further comprising means for downloading said presentation file without a corresponding full file.

20. The computing equipment of claim 13, further comprising means for downloading said presentation file at the same time as the corresponding full file or a trail version of the corresponding full file, wherein said full file or said trial version being functional only under predetermined conditions.

21. A distribution server for enabling an operator to develop a file library associated with a specified user software product remotely in a simple and ergonomic manner, comprising:
means for transmitting destination information to a computing equipment of a user connected to said distribution server via a communications network, said destination information comprising specification of a given location in the file library; and
means for presenting presentation files in said computing equipment of said user at the same time as presentation files corresponding to full files already acquired by the file library of said user.

22. The server of claim 21, further comprising means for transmitting information relating to the terms and conditions of use and acquisition of a full file.

23. The server of claim 21, further comprising means for associating presentation information to a presentation file indicating that a corresponding full file has not been acquired by the file library of said user.

24. The server of claim 21, further comprising means for automatically activating downloading of said presentation files to said computing equipment of said user at a predetermined interval of time.

25. The server of claim 21, wherein the size of a presentation file is substantially smaller than the size of a corresponding full file.

26. The server of claim 21, wherein library files are of three-dimensional type and said presentation files are of two-dimensional type.

27. The server of claim 21, further comprising means for downloading said presentation files to said computing equipment of said user without corresponding full files.

28. The server of claim 21, further comprising means for downloading a presentation file at the same time as a corresponding full file or a trial version of said corresponding full file, wherein said corresponding full file or said trial version is functional only under the conditions predetermined by said computing equipment of said user.
